(19) United States
(12) Patent Application Publication
(10) Pub. No.: US 2025/0126582 A1
(43) Pub. Date: Apr. 17, 2025

(54) VIRTUALIZATION OF SYNCHRONIZATION PLANE FOR RADIO ACCESS NETWORK WITH FRONTHAUL PACKET DELAY VARIATION

(71) Applicant: Dell Products L.P., Round Rock, TX (US)

(72) Inventors: Tomasz Podsiadlik, Dublin (IE); Michael Healy, Scituate, MA (US); Eran Goldstein, Montreal (CA); Jia Liu, Newmarket (CA); Jayaram Venguduswamy Srinivasan, Nepean (CA)

(21) Appl. No.: 18/486,330

(22) Filed: Oct. 13, 2023

(51) Int. Cl. H04W 56/00

(52) U.S. Cl. CPC H04W 56/004

(57) ABSTRACT

Described is synchronization of radio units (RUs) with a reference time and frequency using a reference radio unit (reference RU) without the need for boundary-clock-based synchronization. A synchronized RU transmits a reference signal that is received at the reference RU and used to evaluate its time and frequency. A processing unit coupled to the reference RU evaluates waveform sample data, corresponding to the received signal, with reference waveform data and returns feedback, e.g., frequency error data, time error data, and quality information. The frequency error data and time error data are used to synchronize the RU. Messages between the DU and RU (e.g., via a fronthaul interface) indicate signal start time, stop time and frequency for transmitting by the RU, and for the RU to correct its time and frequency based on the error data. Messaging between the DU and the processing unit coordinates the reference waveform data for evaluation.

### BACKGROUND

Radio units that connect to a distributed unit via Ethernet are often used in fourth-generation (4G) and fifth-generation (5G) cellular communication. Modern wireless radio access networks (RAN) use a fronthaul interface to exchange data between a distributed unit (DU) and radio units (RU). While C/U (control/user) planes carry most data traffic, they readily accept some packet delay variation (PDV) within their time windows without impacting the performance of the RAN.

However, using the same interface to send C/U and Precision Time Protocol (PTP)-based synchronization plane (S-Plane) messages, as specified by O-RAN, requires careful evaluation of the permitted PDV in the Fronthaul. This is because radio units base their time on the PTP and SyncE.

The fronthaul interface carries management plane (Management-Plane), control plane (Control-Plane), user plane (User-Plane), and synchronization plane (Synchronization-Plane). Varying delays of S-Plane packets reaching their destinations can negatively impact synchronization quality. The packet delay variation often results from the insertion of switches between the transmitting and receiving nodes, and because they need to pass traffic from different sources with varying instantaneous throughput. In addition, the encryption of PTP packets may impose challenges associated with scalability or determining latency.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of an example system (e.g., in an open-radio access network (O-RAN) architecture) in which switches do not need boundary clocks for synchronization because of waveform-based synchronization of radio units, in accordance with various aspects and implementations of the subject disclosure.

FIG. 2 is an example block diagram representation of a system in which the reception of a waveform enables the assessment of the time and frequency errors relative to a reference waveform for synchronizing a radio unit, in accordance with various aspects and implementations of the subject disclosure.

FIG. 3 is an example block diagram representation of time and frequency synchronization of a radio unit with a distributed unit based on a reference waveform versus a received waveform, in accordance with various aspects and implementations of the subject disclosure.

FIG. 4 is an example block diagram representation of a frequency synchronization loop, in accordance with various aspects and implementations of the subject disclosure.

FIG. 5 is an example block diagram representation of a time synchronization loop, in accordance with various aspects and implementations of the subject disclosure.

FIG. 6 is an example timing-based representation of a synchronization model, in accordance with various aspects and implementations of the subject disclosure.

FIG. 7 is an example timing-based representation of a synchronization example, in accordance with various aspects and implementations of the subject disclosure.

FIG. 8 is an example block diagram representation of a processing unit that correlates reference waveform data with received waveform data, in accordance with various aspects and implementations of the subject disclosure.

FIG. 9 is an example block diagram representation related to the initial synchronization of a radio unit, in accordance with various aspects and implementations of the subject disclosure.

FIG. 10 is an example block diagram representation of a fronthaul interface that couples a distributed unit to a radio unit, in accordance with various aspects and implementations of the subject disclosure.

FIG. 11 is an example block diagram representation of extending network coverage without timing support, in accordance with various aspects and implementations of the subject disclosure.

FIG. 12 is an example block diagram representation of extending network coverage without timing support where radio units are connected to a distributed unit via the internet, in accordance with various aspects and implementations of the subject disclosure.

FIG. 13 is a flow diagram showing example operations related to synchronizing a radio unit with a distributed unit based on time error data, in accordance with various aspects and implementations of the subject disclosure.

FIG. 14 is a flow diagram showing example operations related to synchronizing a radio unit with a distributed unit based on error correction data obtained via a transmitted reference waveform and received waveform, in accordance with various aspects and implementations of the subject disclosure.

FIG. 15 is a flow diagram showing example operations related to determining error correction data based on received radio signal data and reference waveform data, and communicating the error correction data to a distributed unit for synchronization of a radio unit, in accordance with various aspects and implementations of the subject disclosure.

FIG. 16 is a block diagram representing an example computing environment into which aspects of the subject matter described herein may be incorporated.

FIG. 17 depicts an example schematic block diagram of a computing environment with which the disclosed subject matter can interact/be implemented at least in part, in accordance with various aspects and implementations of the subject disclosure.

### DETAILED DESCRIPTION

Various aspects of the technology described herein are generally directed towards using a transmitted reference waveform and the resultant received waveform to determine time error data and frequency error data of the transmitting radio unit (RU). In one example implementation, a reference radio unit is used for reference time and frequency (e.g., instead of PTP or GNSS-based solutions), which reduces the synchronization vulnerability from the packet delay variation in the fronthaul interface.

The technology described herein facilitates the deployment of radio units without full timing support in the Ethernet network, providing for cost-efficient deployment. Further, the technology described herein facilitates straightforward implementation of security mechanisms such as the fronthaul interface. In one example implementation, the technology described herein can be incorporated into an O-RAN architecture.

Thus, in general, the technology described herein reduces the RU's synchronization dependency because of packet delay variation (PDV). Subsequently, the fronthaul network requirements, especially with respect to timing aspects, can be significantly simplified. The technology can, for example, allow a more straightforward addition of desired security features media access control security (MACSec) in the fronthaul interface.

Reference throughout this specification to “one embodiment,” “an embodiment,” “one implementation.” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimization.” “optimize” or “optimal” and the like (e.g., “maximize,” “minimize” and so on) only represent objectives to move towards a more optimal state, rather than necessarily obtaining ideal results.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

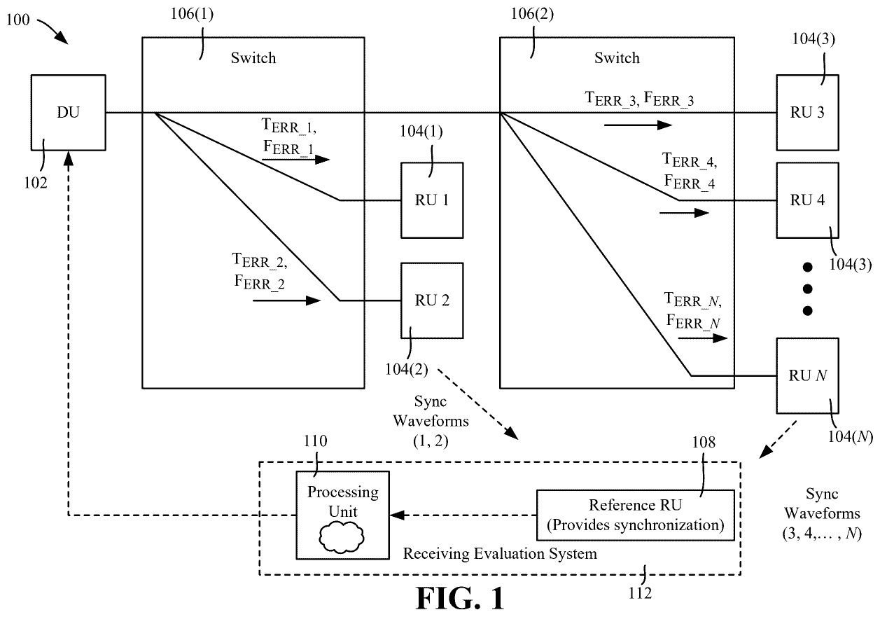

FIG. 1 shows an example system/architecture 100, representing a modern wireless radio access network (RAN) that uses a fronthaul interface to exchange data between a distributed unit (DU) 102 and radio units (RUs) 104(1)-104(N) (collectively referred to herein as 104). The fronthaul interface carries management, control, user, and synchronization data called synchronization-plane (S-Plane) data. Varying delays of S-Plane packets reaching their destinations can negatively impact synchronization quality.

The packet delay variation often results from the insertion of switches (e.g., 106(1) and 106(2) between the transmitting and receiving nodes (in this implementation the DU 102 and the RUs 104). This is because the switches 106(1) and 106(2) can pass traffic from different sources with varying instantaneous throughput. In the example of FIG. 1, the switches 106(1) and 106(2) can introduce packet delay variation and packet jitter, whereby every network node between the DU 102 and any RU 104 risks degradation of the time synchronization between the DU 102 and the RUs 104.

Ensuring that the S-Plane is not impacted by packet delay variation, e.g., the DU 102 and the RUs 104 are closely synchronized, is addressed in Open-RAN (O-RAN) standards, which mandates full-ITU-T G.8275.1-or partial-G.8275.2-timing support, adding boundary clocks to all or selected nodes. For example, each network node between a RU and Precision Time Protocol (PTP) master (e.g., at the DU 102) can support a PTP slave, for synchronizing to the preceding PTP master. The problem of needing full-timing support results in the additional cost of necessary network equipment and time to upgrade an existing network, for example. In addition, scaling the network necessitates the installation of nodes that support boundary or transparent clocks. Still further, while encryption of the fronthaul traffic is a desired feature, encryption of PTP packets can affect synchronization because it can be difficult to determine the latency added by computing the integrity check value (ICV), and also can add timestamping errors in some scenarios.

Described herein is a synchronization technology that, based on waveform data processing, facilitates the use of switches without the need for boundary clocks. To this end, as shown in the example implementation of FIG. 1, a reference radio unit 108 receives a waveform transmitted from each RU 104, and provides corresponding received waveform data to a waveform data processing unit 110. The reference RU 108 can be connected to GNSS or can be provided with a low-error time source, whereby a synchronized RU 104 can be synchronized with respect to time and frequency to the reference RU 108. In one implementation, the waveform data processing unit 110 obtains reference waveform data corresponding to the radio signal data (as received by the receiving evaluation system prior to transmission), and evaluates sample received waveform data (after transmission) relative to the reference waveform data. In general, the received waveform results in time error data T_{ERR} and/or frequency error data F_{ERR} relative to the reference waveform, which can be used as described herein to synchronize the radio unit that transmitted the waveform with the DU 102. Note that the reference radio unit 108 and the waveform data processing unit 110 can be considered components of a receiving evaluation system 112, as both cooperate to synchronize the DU 102 and the radio units via evaluation of the received waveform data versus reference waveform data, (even though, for example, the reference radio unit 108 can be located in a cell coverage area while the processing unit can be a remote cloud component).

In sum, the technology described herein facilitates reduced dependency on boundary-clock-based synchronization for resolving packet delay variation, and thus can work on older networks that do not have timing support. Indeed, by implementing the technology described herein, packet delay variation has a significantly reduced impact on the synchronization. Subsequently, the same security mechanisms can be applied to the control plane (C-Plane), user plane (U-Plane) and S-plane, making the security design less challenging. For example, RUs can be connected to DUs through non-SyncE/non-PTP/low-cost ethernet switches, thus lowering the system cost and complexity.

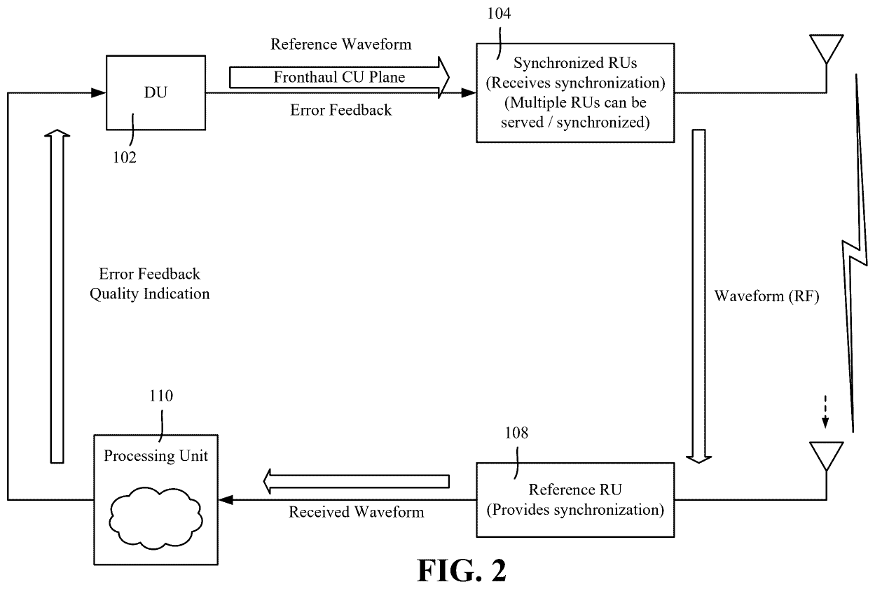

FIG. 2 shows a high-level block diagram example of the technology described herein for synchronizing the time and frequency of a radio unit in the fourth generation (4G/LTE) and fifth generation (5G) cellular networks, (and likely beyond 5G). In general, the synchronized RUs 104 receive a reference waveform from the DU 102 and transmit respective reference waveforms to the reference RU 108. Based on the respective differences (timing and/or frequency errors) of the received waveform data relative to the reference waveform data as determined by the processing unit 110, which knows the reference waveform (e.g., via coordination with the DU 102), the respective error data of the respective waveforms can be returned to the respective RUs 104 for use in synchronizing with the DU 102. Thus, unlike existing solutions (e.g., of RUs needing fronthaul S-Plane or GNSS (Global Navigation Satellite System) signals if available, i.e., without obstacles or jamming, and thus direct, point-to-point connection from the PTP master to RU or switches that ensure low packet delay variation), the synchronized RUs 104 as described herein do not receive synchronization but instead transmit a reference signal over the air (OTA) to a reference unit 108. The reception of the waveform enables the assessment of the time and frequency errors, e.g., by a separate processing unit 110, which returns a correction request to the synchronized RU 305 (e.g., via DU 102 messaging). Note that although the reference RU 108 does need to receive high-quality reference time via PTP or GNSS, this is only one component that can be deployed relatively quickly and inexpensively in a network. As a result, the technology described herein reduces the S-Plane reliance on PTP in the fronthaul interface, relaxing the requirements and using existing networks to extend RAN coverage by radio units, (that is, without needing boundary or transparent clocks that may necessitate network upgrades and increase deployment costs) and thereby may be a cost-efficient and fast-to-deploy alternative for existing topologies.

A general role of the reference RU is to receive the waveform from the synchronized RUs 104, and for each waveform, sample the waveform using a time source that allows adjustment of a receiving window with high accuracy, sufficient to extract time error data. In addition, the RU oscillator's frequency also needs relatively high accuracy to compute the errors. A reference RU can be characterized by (but is not limited to) the following:
RX only needed-low-cost, low power consumption, reception only (TX is not needed).
The reference RU can receive its time and frequency from a network using PTP. In such a scenario, a low-speed interface, e.g. compared to 10 Gbps Ethernet, is sufficient.
The reference RU can receive its time and frequency from GNSS or other sources.
Low RF bandwidth.
RX frequency can be adjusted if served (synchronized) RUs use frequency resources outside the reference RU's bandwidth, enabling low RF BW operation.

The implementation of reference RUs can leverage designs based on Open-RAN radio units, which require some complexity, or they can be built as a cost-efficient devices similar to existing 4G/5G modems but without the transmitter. Such reference RUs need to have reliable internet connectivity (e.g., via an RJ45 port) along with synchronization based on PTP, GNSS receiver, or another dedicated interface.

Because of the transmission of the waveform, the technology described herein also provides for further control (relative to existing methods) when accessing the synchronization. For example, as shown in FIG. 2, in addition to the error feedback, the DU 102 can receive quality indicator information based on the transmitted reference signal, and thereby know that the reference signal had reached the reference RU with a poor-quality signal, so as to increase power for subsequent transmitted reference signals and/or leverage beamforming to access more a distant reference RU.

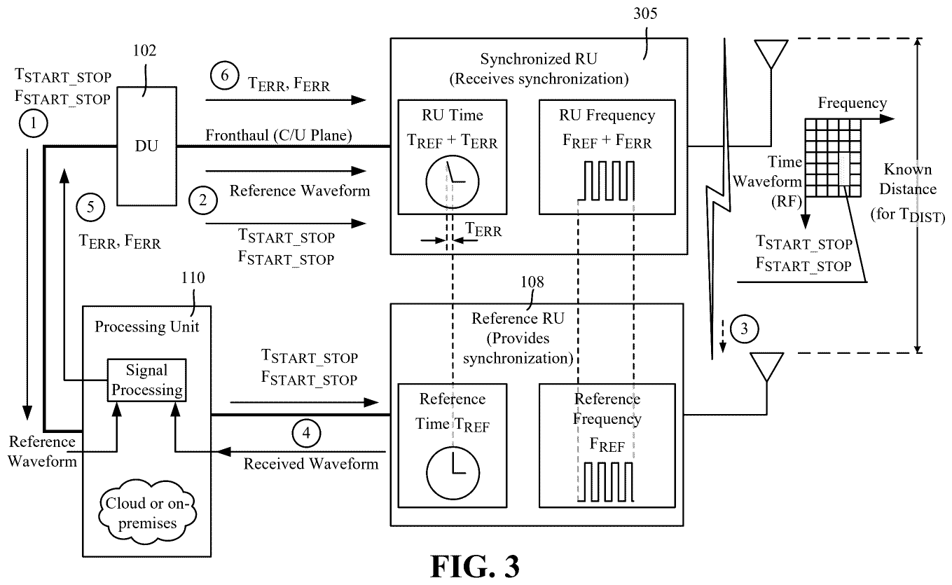

FIG. 3 shows additional details of the components that create a time and frequency control loop for a synchronized RU 305. In general, the synchronized RU 305 in FIG. 3 belongs to a cell that transmits and receives data to and from user equipment, such as (but not limited to) mobile devices, IoT devices, low-cost user equipment (UE), and so on. To operate correctly, the RU 305 needs to meet the time and frequency requirements listed in O-RAN CUS-plane specification, for example). At any time prior to synchronization by waveform data evaluation, the DU 102 and the processing unit 110 can coordinate with each other (labeled arrow one (1)) so that the reference waveform to be transmitted is known by the processing unit 110 and the DU 102.

As shown in FIG. 3, the synchronized RU 305 communicates with a distributed unit 102 via a fronthaul interface, which carries user, control, and management plane (M-Plane) data. In one example implementation, a synchronization cycle starts (labeled arrow two (2)) when the DU 102 sends a predefined waveform and a transmission request (a message or messages) to the synchronized RU 305. The message(s) carries IQ sample data (where I is the real part and Q the imaginary part) and information about the time and frequency the RU 305 is to use for transmission over the air.

When transmitted by the synchronized RU 305, the waveform propagates (labeled arrow three (3)) to the reference RU 108 in a known time denoted as T_{DIST} as described herein, based on the distance between the synchronized RU 305 and the reference RU 108. The reference unit 108 connects to high quality time and frequency sources such as GNSS or PTP/SyncE. In one implementation, the reference RU 108 receives the reference waveform and (knowing the transmission/reception time and frequency) forwards the waveform data as a set of IQ samples to the processing unit 110 at labeled arrow four (4); the processing unit 110 can be a cloud-based service, such as triggered by events such as data upload.

The processing unit 110 compares the received sample data to the reference waveform and returns values to the DU 102 and via message(s) to the synchronized RU 305 (labeled arrows five (5) and six (6)), by which the synchronized RU 305 corrects its time and frequency. The processing unit 110 can compute the time error by knowing the geographical location of the RUs, i.e., it knows and compensates for the propagation timeTDIST. In this way, the synchronized RU 305 resynchronizes to the reference frequency and time (ToD) based on the received values. The synchronization cycle occurs occasionally (e.g., periodically or otherwise) to maintain the correct time and frequency of the synchronized RU 305, and similarly for other synchronized RUs.

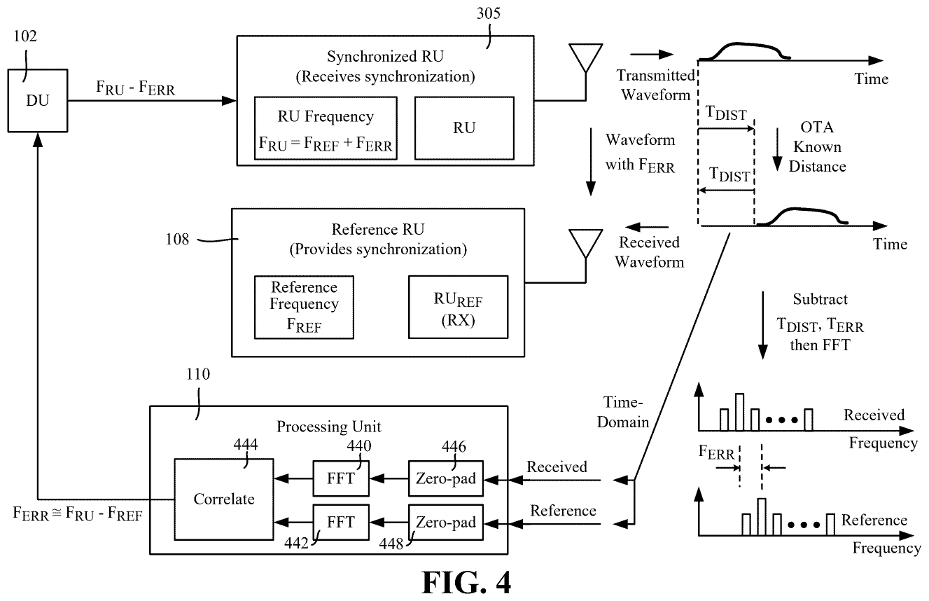

Turning to frequency synchronization (correction), FIG. 4 shows example components of a frequency synchronization loop. As described herein, the synchronized RU 305 transmits the predefined reference waveform at the expected frequency and time. The reference RU 108 receives the waveform and forwards corresponding waveform data (e.g., IQ samples) to the processing unit 110, e.g., using an Internet connection or a local network connection.

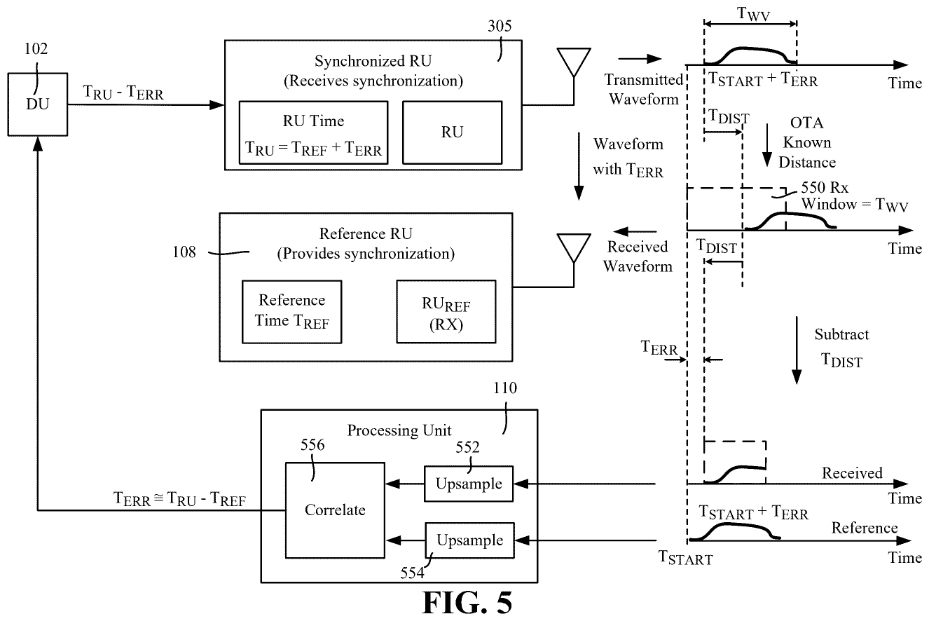

The processing unit 110 subtracts the time offset that results from the wave propagation T_{DIST}, known to the processing unit 110, and the time error T_{ERR}, (described with reference to FIG. 5). The processing unit 110 then compares the received waveform to the reference waveform in the frequency domain. This is shown via the FFTs 440 and 442 (fast Fourier transform components) and the correlate operation (block 444). The result is frequency error data F_{ERR} sent from the processing unit 110 to the DU 102, which forwards the frequency error data F_{ERR} to the synchronized RU 305. The synchronized RU 305 uses the received error value F_{ERR} to correct its transmit frequency, e.g., by changing the voltage applied to its voltage-controlled oscillator (VCO); (where the VCO is an electronic component that allows tuning the frequency in the closed loop; it may be possible to use components for that purpose). More generally, the main components in the synchronized RU 305 can benefit from the frequency error correction using the best available clock source—the VCO. For example, a low-frequency error in the clock for the time circuit will result in a lower time errorT_{ERR}. Examples of other RU subsystems that can benefit from the F_{ERR} correction include, but are not limited to, Ethernet PHY and signal processing such as low-PHY and digital front end.

The general goal of the signal processing is to return the frequency error with sufficient accuracy, such as based on the frequency error requirement specified by the third generation partnership project (3GPP), in which a wide area base station has the error specified as ±0.05 ppm, and a medium range base station and local area base station have the error specified as ±0.1 ppm. Note that a ±0.1 ppm frequency error is not a limitation of the technology described herein, but rather only a possible value used herein in examples; indeed, the technology described herein may achieve ±0.05 ppm or better resolution, for example.

The frequency error in ppm can be expressed in Hertz (Hz), to be used in the calculation of the required granularity of FFT.

$${F}_{E R R - H z} = {F}_{C} \cdot {F}_{E R R - p p m} \cdot {10}^{- 6}$$

The table below lists some frequency (in Hz) values corresponding to +0.1 ppm frequency error for different values of carrier frequency:

Frequency error in Hz-±0.1 ppm.

| | Resolution requirement- |
|---|---|
| Carrier frequency | maximum frequency error, assuming ±0.1 ppm |
| (GHz) | (Hz) |
| 1 | 100 |
| 2 | 200 |
| 3.5 | 350 |
| 4 | 400 |

The FFT's frequency resolution equals the sampling frequency ratio used to the number of samples:

$${F}_{R E S} = \frac{{F}_{S}}{{N}_{S A M P L E S}} = \frac{{F}_{S}}{{N}_{F F T}}$$

where F_{S} is the sampling frequency of the waveform received by the processing unit 110, and N_{SAMPLES}, N_{FFT} represent the length of the waveform after zero-padding.

Many waveforms used in wireless communication have their subcarrier spaced wider than the desired granularity. For example, PRACH preamble format 0 uses 1.25 kHz subcarrier spacing compared to 350 Hz maximum frequency corresponding to F_{C}=3.5 GHZ (in the above table). The desired frequency resolution can be achieved by extending the received samples by zero-padding (blocks 446 and 448, FIG. 4) IQ₁, IQ₂, . . . , IQ_{N}, 0_{N+1}, 0_{N+2}, . . . , 0_{N}_{_{FFT}}}.

The respective zero-padded waveforms are fed to the respective FFTs 440 and 442, and correlated (block 444) in the frequency domain with the reference. The resulting frequency error indicates how much correction will be needed at the synchronized RU 305. The above processing can be applied to PRACH based, SSB based, or other waveforms that need to meet the desired frequency requirement. Note that no specific type of waveform is specified; however, a good candidate waveform should ensure correlation in the time and frequency domains to ensure high-accuracy synchronization. For example, longer waveforms will allow denser subcarrier spacing useful for correlating in the frequency domain. In addition, low bandwidth will help reduce overhead and save resources. Waveforms considered include SSB. CSI-RS, and PRACH preamble format 0, but other waveforms or even a new type of waveforms can be used.

Turning to time synchronization, FIG. 5 shows example components used in one implementation for time synchronization. As described herein, the synchronized RU 305 transmits a predefined reference waveform, at the expected frequency and time. The transmission time includes an error T_{ERR} resulting from the RU's time of day source. This error can result from time drift due to oscillator frequency error or other factors.

The reference RU 108 knows the transmission time and frequency and has its receive (Rx) window 550 aligned to capture the waveform. For better performance, the reference RU 108 may delay its RX Window by the T_{DIST} time, which is not shown in FIG. 5. The reference RU forwards the sampled waveform to the processing unit 110 as generally described with reference to FIG. 4. In general, processing unit 110 subtracts the known offset due to the over-the-air propagation time T_{DIST}, increases the sampling frequency to achieve desired time resolution, and correlates both waveforms, returning the T_{ERR} value to the DU 102. In turn, the DU forwards the value of T_{ERR} to the synchronized RU 305 with a request message to correct the synchronized RU's time. This operation is repeated occasionally (e.g., periodically) to maintain the required time alignment of the synchronized RU, generally, but not necessarily, in conjunction with frequency correction.

Note that for purposes of visibility, FIG. 5 exaggerates the time to propagate the waveform T_{DIST} and time error T_{ERR} relative to the waveform length T_{WV} to demonstrate the principle of operation. In practice, only a small fraction of the waveform will fall outside the receive window 550, which may be recovered using cyclic prefix samples when T_{ERR} is positive, for example.

In one example implementation, the time-related signal processing inside the processing unit 110 of FIG. 5 starts with interpolating, e.g., upsampling and filtering, blocks 552 and 554) received and reference waveforms. The interpolation increases the resolution for computing time error to reach the desired granularity expressed by:

$${T}_{R E S} = \frac{1}{{F}_{S} \cdot {N}_{INTERPOLATE}}$$

where F_{S} is the sampling frequency of the waveform received by the processing unit 110 and N_{INTERPOLATE} represents how many times the Upsample module increases its sampling frequency.

An example of interpolation for a specific waveform's bandwidth as described below with reference to an experimental example. The waveforms are next correlated (block 556), returning time error T_{ERR}.

The control loop in FIG. 5 can be analyzed for monitoring and controlling RU time. The synchronization loop needs to ensure that the synchronized RU meets and maintains the required time accuracy. The 3GPP standards specify the maximum time error at the cell's antenna as 3 μs, which can be interpreted as ±1.5 μs. Subsequently, T_{REQ}=1.5 μs is used herein as the maximum acceptable value for the time error.

It is assumed that the synchronized RU uses one clock oscillator to synthesize the time-of-day and radio transmission (or other/other device) frequency. Based on the standards, the frequency error for both should not exceed ±0.1 ppm. as described with reference to FIG. 4.

Assuming F_{ERR-MAX}=0.1 ppm, the maximum drift of time per time unit is:

$${T}_{DRIFT} ≅ {F}_{ERR - MAX} \cdot t .$$

For example, time drift per 1s is approximated as:

$${T}_{D R I F T - 1 s} ≅ 0 \text{.1} [ ppm ] \cdot 1 [ s ] = 0.1 μs .$$

The theoretical maximum period of resynchronization that ensures the RU does not exceed the required T_{REQ}=1.5 μs becomes 15s, as calculated below.

$${T}_{S Y N C} < \frac{{T}_{R E Q}}{{F}_{E R R}} = \frac{1.5 [ μs ]}{0 \text{.1} [ ppm ]} = 15 [ s ]$$

Note other (e.g., existing) commercial solutions may use more advanced algorithms. The calculation aims only to baseline initial assumptions for the time synchronization loop.

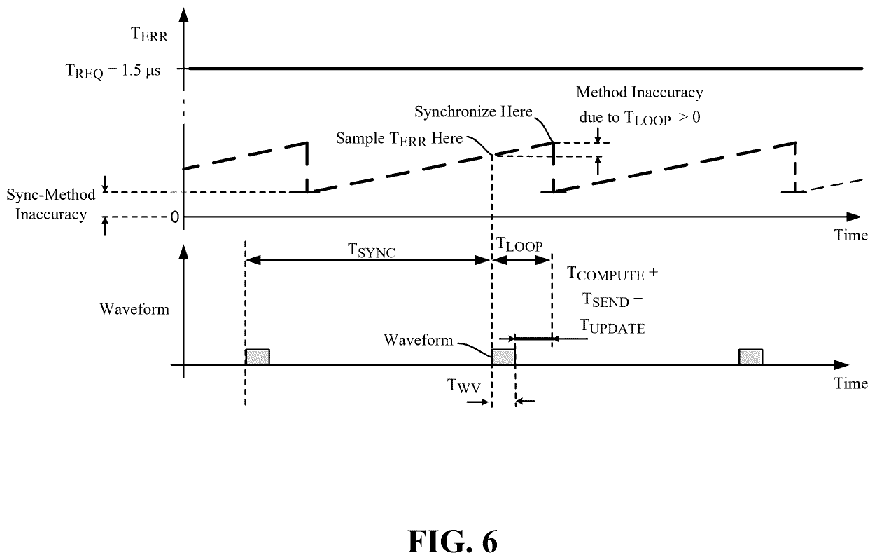

The operation of the time synchronization loop includes several operations described with reference to the control loop model of FIG. 6. For one, the transmission of the waveform corresponds to measuring (sampling) the time error of the synchronized RU 305 (FIGS. 3-5). Further, the loop needs T_{LOOP} time to send, process the waveform, and return the feedback to the synchronized RU 305. While waiting for the input, the RU's time error T_{ERR} continues to increase. In another operation, the RU receives the feedback and resynchronizes.

Because of some expected inaccuracies, e.g., time resolution or a long T_{LOOP}, the resynchronization can result in some errors. The analysis of the method inaccuracy and their mitigation can be evaluated in a given system. Factors can include reference time, frequency-accuracy (expecting that the reference RU will have a nonzero time and frequency errors, impacting the achievable synchronization accuracy); frequency and time loops (the time to compute errors and return their values to DU impacts the accuracy of time synchronization) and FaaS considerations, e.g., the FaaS may need to create a container (if a warm container is unavailable) to execute the function. When it happens, the loop's response can increase to 1s or above, impacting synchronization. Generally, cold starts can and should be avoided. Other factors can include frequency and time error measurement resolution, which depends on the length of the waveform and sampling frequency, and multipath propagation that can cause fading, which will degrade the received waveform, and can also affect the time error measurement by correlating with a reflected signal whose propagation time (T_{DIST}) is longer.

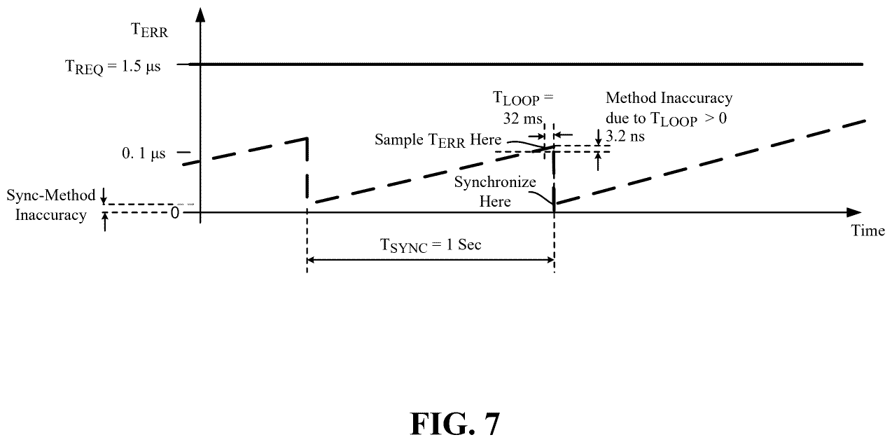

FIG. 7 shows a control loop example given a known resynchronization period, loop time, and the frequency error, which are used to approximate the accuracy and maximum error. The example of FIG. 7 uses 1s for resynchronization and loop times, and the following:
T_{WV}=1 ms
   This example uses an 800 μs waveform similar to the PRACH preamble format 0. This length is rounded up to 1 ms with negligible impact on the loop's performance analysis.
T_{COMPUTE}=20 ms.
   This is the value measured for computing T_{ERR} and F_{ERR} on a virtual machine with a 1-processor core.
T_{SEND}=10 ms.
   This is assumed time needed to send the waveform samples from the reference RU to the processing unit, and to send the resulting T_{ERR} and F_{ERR} to the synchronized RU.
T_{UPDATE}=1 ms.
   it is assumed that the synchronized RU needs to schedule the time and frequency updates.

The above are added to model the time needed for the loop to respond:

$${T}_{LOOP} = {T}_{W V} + {T}_{COMP} + {T}_{SEND} + {T}_{UPDATE} = 32 ms .$$

FIG. 7 shows the predicted values of the time error, marking the method inaccuracy caused by resolution and loop time. With T_{LOOP}=32 ms, the time error of T_{ERR}≈0.1 μs<<1.5 μs already provides a sufficient margin to operate within the required range. Note that it is feasible for the loop's accuracy to be optimized by reducing the synchronization period, resolution, and loop time.

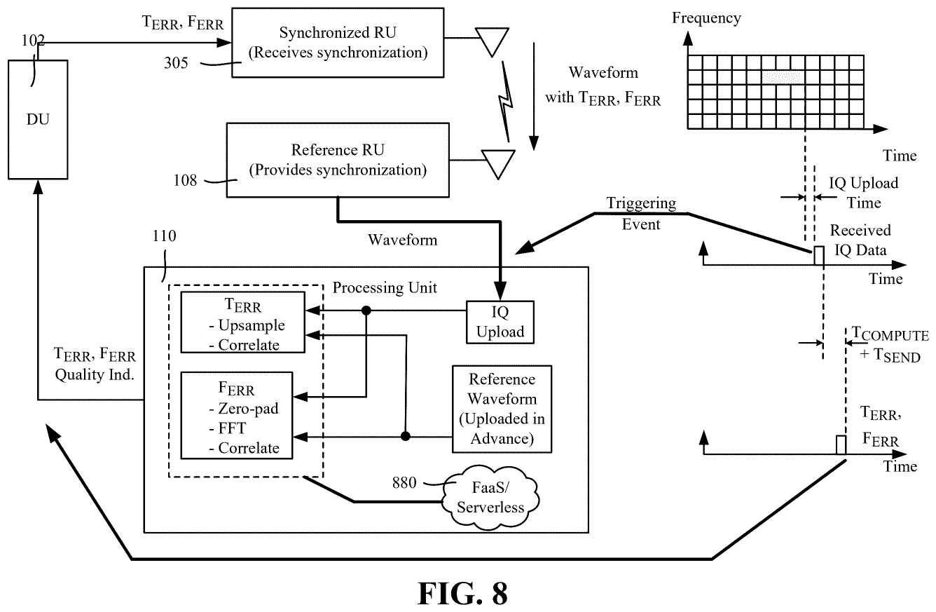

As generally represented in FIG. 8 and as described herein, a general role of the processing unit 110 is to process the received waveform and return in (possibly) the shortest time, the values of time and frequency errors, and (desirably) information about the quality of the received signal. To the extent possible, the waveform data computing/processing unit should be scalable, low-cost, and support software upgrades. For example, a processing unit 110 incorporating or coupled to act as function-as-a-Service (FaaS) offers users execution of code written in the programming language of choice. The code (function) typically executes in response to events such as data upload. FaaS offer scalability, accessibility—as any cloud service, and simplicity in deploying—the developer is not concerned by the underlying infrastructure. For example, FaaS 880 can serve multiple DUs and RUs. In addition, FaaS can be based on commercial-cloud solutions or implemented by leveraging open-source projects, thereby making the FaaS a suitable candidate for implementing the processing unit.

Thus, in one or more example implementations, code for processing the received waveform can be written in the programming language of choice. The function executes in response to the upload, and when the computing finishes, FaaS 880 returns the output to the DU 102. Single instance of the function can serve multiple requests from many DUs, and scale up/down automatically as per the received traffic.

By way of an experimental example, one experiment used a prototype code written in GNU Octave (.m) to process a waveform, measure time and frequency errors, and report the time needed to process the data T_{COMPUTE}. The implementation is to meet frequency and time synchronization requirements of T_{ERR}<1.5 μs and F_{ERR}<0.1 ppm or better. The function can accommodate different parameters that scale automatically, using the values described below.

The waveform used in the experiment has properties similar to PRACH preamble format 0, e.g.,
849 subcarriers
SCS=1.25 kHz

$$BW = 849 \times S C S = 1.06 MHz$$

LTIME=24576 samples in time domain
Initial sampling frequency is 30.72 MHZ

$${T}_{W V} = \frac{24576}{30.72 MHz} = 800 μs$$

The carrier frequency value is used to express frequency error in Hz. This experiment used F_{C}=3.5 GHz—as for 5G NR band n78 (C-Band, 3300-3800 MHZ). To meet the requirement of F_{ERR}<0.1 ppm, the frequency resolution needs to be better than 350 Hz from the above table. Therefore, assume a resolution of 100 Hz, that is, F_{RES}=100 Hz or better.

The time error needs to meet the assumed requirement of T_{ERR}<T_{REQ}=1.5 μs. This example experiment assumes a resolution that leaves some margin below the required value, that is, T_{RES}=50 ns (T_{RES}=0.05 μs) or better.

The sampling frequency of the waveform sent from the reference RU should have the smallest possible value above the Nyquist frequency to keep the payload size-corresponding to the samples sent to the processing unit-small. Therefore, the reference RU performs decimation by a factor of 24 to reduce the payload of samples sent to the processing unit:

$${F}_{S} = \frac{30.72 MHz}{24} = 1.28 Hz > {f}_{N y q uist} = 1.06 MHz .$$

Subsequently, the length of the waveform for sending to the processing unit and the size of the FFT becomes:

$${N}_{F F T} = \frac{24576}{24} = 1024 .$$

With respect to the payload size, if the waveform data is sent as time domain IQ samples, 32 bits (4 bytes) per IQ pair, then the payload that the reference RU sends to the processing unit becomes:

$${IQ}_{PAYLOAD} = {N}_{F F T} \cdot Wordlength [ B ] = 1024 \cdot 4 [ B ] = 4096 [ B ] .$$

With respect to time error-related signal processing, the function (processing unit 110) interpolates the received waveform by factor of 16, which results in desired time resolution below 50 ns:

$${T}_{R E S} = \frac{1}{{F}_{S} \cdot {N}_{INTERPOLATE}} = \frac{1}{1.28 MHz \cdot 16} = 48.8 ns < 50 ns .$$

The interpolation factor in FIG. 5 becomes 16.

With respect to frequency error-related signal processing, the function (processing unit) zero-pads the received waveform, extending it to the total length of 12800 samples, which results in desired frequency resolution of 100 Hz.

{{1024 received samples}, {11776 samples by zero-padding}}=={12800 samples total}. Consequently,

$${F}_{R E S} = \frac{{F}_{S}}{1024 + 11776} = \frac{1.28 MHz}{12800} = 100 Hz .$$

The FFT length in FIG. 4 becomes 12800, the zero padding adds 11776 samples (zeros).

The experiment used a virtual machine with a single x86 i7 processor at 2.7 GHZ to simulate the possible processing capability of FaaS. The time to process the data by the prototype function was measured by timestamping after the waveform generation (input to the function) and after the function returned time and frequency errors. To validate that the accuracies are as targeted, the processing unit was fed a waveform with time and frequency error values: T_{ERR}=781.25 ns, F_{ERR}=−551 Hz. The resultant output indicated that the time and frequency errors are computed within the expected granularity and meet the assumed accuracy requirement.

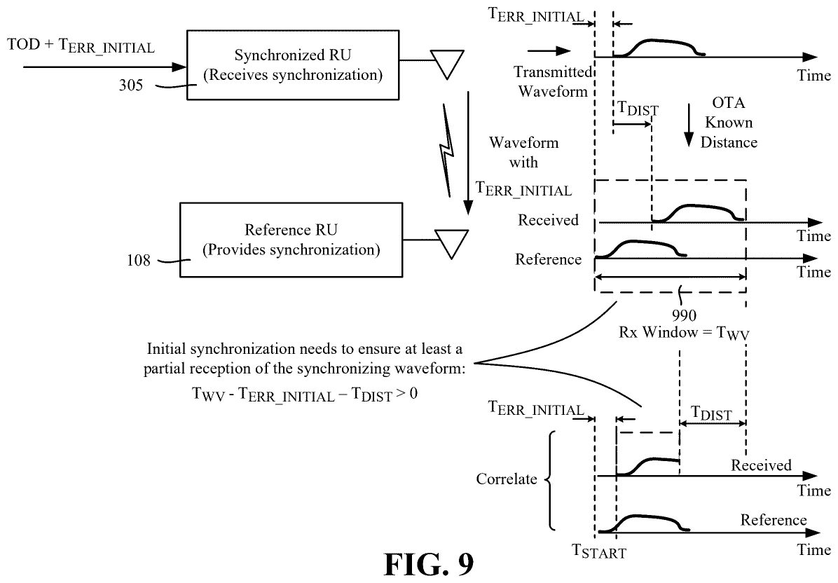

Turning to initial synchronization as generally represented in FIG. 9, initial synchronization occurs after the power-up or restart of an RU. As a result, the time error is likely too large to transmit the waveform within a predictable time boundary and perform the closed-loop synchronization. Thus, initial synchronization aims to set the RU's time so that the reference RU receives at least part of the waveform within its RX window. The received portion of the waveform needs to be sufficient to correlate it with the reference waveform data.

During its normal operation, the (synchronized) RU requires 1.5 μs or better time accuracy. On the other hand, the initial synchronization can accept the time error that depends on the distance and the waveform length. This time error can be several hundreds of microseconds or more, which is a much higher value than during normal operation (1.5 μs). This wide error margin motivates a different approach to initial synchronization.

An example initial synchronization process is shown in FIG. 9, expressed by the condition T_{WV}−T_{ERR-INITIAL}−T_{DIST}>0. As such, T_{ERR-INITIAL}<T_{WV}−T_{DIST}. Note that during the initial synchronization, the synchronized RU needs its fronthaul RX window to accommodate the likely significant time error T_{ERR-INITIAL}. However, RU's RX window extension is needed only during the initial synchronization, and does not require an increase in memory to buffer the data in the RU.

O-RAN defines interoperability profiles with minimum and maximum fronthaul latency between the O-DU and O-RU. For example, IoT profile specs constrain the maximum latency as T12_max=160 μs (maximum latency from O-DU to O-RU). Subsequently, the maximum error addition in the received time of day is expected to be T_{ERR-INITIAL}<160 μs.

For example, consider that the synchronizing waveform's length is T_{WV}=800 μs, T_{ERR-INITIAL}=160 μs, and the propagation time is T_{DIST}=1 μs (300,000 km/s, distance=0.3 km or 0.186 mi antenna-to-antenna distance). Subsequently, the reference RU receives a 639 μs-long part of the transmitted waveform, which is sufficient for correlating the received samples to the reference:

$${T}_{W V} - {T}_{E RR - INITIAL} - {T}_{DIST} = 800 μs - 160 μs - 1 μs = 639 μs > 0$$

After the first transmission of the waveform, the time accuracy of the RU will begin converging to the highest possible accuracy of the loop during subsequent iterations, meeting the requirement T_{ERR}<T_{REQ}=1.5 μs. Large values of error resulting from fronthaul delay or packet delay variation can be mitigated by extending length of the waveform until T_{ERR-INITIAL}<T_{WV}−T_{DIST} is met. Thus, initial synchronization is possible even if the network adds significant packet delay variation and latency.

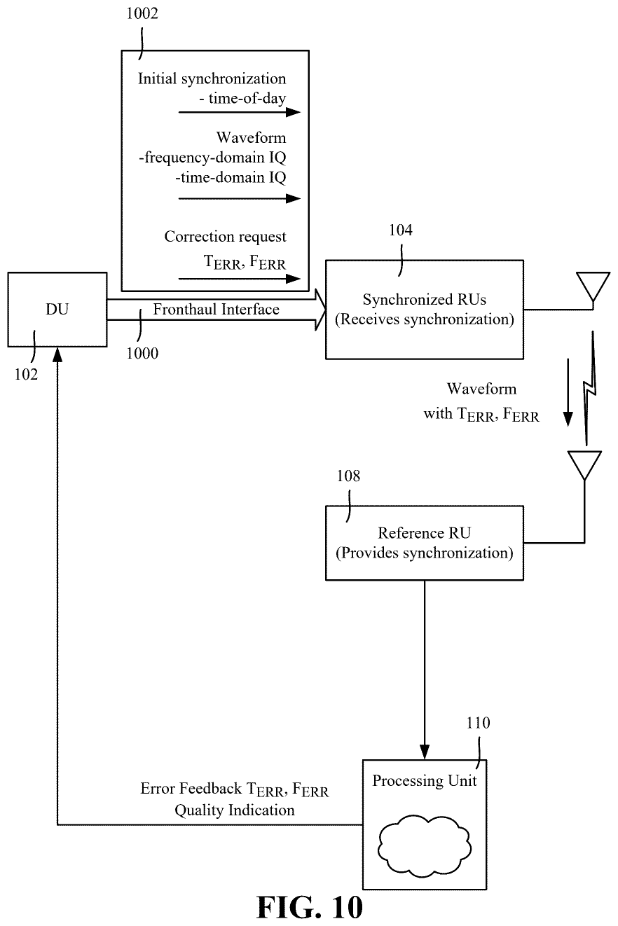

With respect to messaging, the RU interface (e.g., the fronthaul interface 1000 of FIG. 10) that receives synchronization includes various types of messages (block 1002). A first type occurs after starting (power-up) the RU and allows initial time synchronization with accuracy sufficient to transmit the first synchronization waveform as described with reference to FIG. 9. A second message type defines the waveform the RU will transmit at a specific time and frequency resource; this message can include a sequence of IQ samples in the time or frequency domain. A third message type carries the request to resynchronize time and frequency.

The initial synchronization message (the top arrow in block 1002) carries the time-of-day (TOD) information needed to set the timer of the synchronized RU. The time format can follow PTP V2 (seconds, nanoseconds, and fractions of nanoseconds) contained in a ten byte payload.

The waveform information, which can be sent in multiple messages, is shown via the middle arrow in block 1002. For the frequency part, the DU sends the synchronizing waveform to RU as a set of frequency-domain IQ samples in the U-Plane message(s). Note that O-RAN U-Plane messages already provide the time and frequency resource information in U-Plane messages headers and payload as radio frame, subframe, slots, symbol (time information), and resource block (frequency information) numbers. Subsequently, the reuse of the existing O-RAN message format is possible. The synchronized RU can process these messages as standard U-Plane messages.

For the time part, the DU sends the synchronizing waveform to RU as a set of time-domain IQ samples in a custom U-Plane message (e.g., not currently defined in O-RAN). The same message also carries time and frequency information that tells when and at which frequency the RU is to transmit the waveform: T_{START}, T_{STOP}, F_{START}, and F_{STOP}. The RU also receives information about the sampling frequency used on the waveform, F_{S-VW}. The message may also carry information necessary to scale the waveform, send it at specific power (dBm), or request to increase or reduce its amplitude, based on feedback from the reference RU.

The synchronized RU uses the F_{S-VW}. T_{START}, and F_{START} to interpolate, frequency-shift, and add the samples to the time-domain stream of IQ samples. The RU can use T_{START}. T_{STOP}, F_{START}, and F_{STOP} to check that the waveform does not conflict with already used resources.

The correction request message type (bottom arrow in block 1002) is the time and frequency correction request, T_{ERR} and F_{ERR}. The values can be positive and negative, and ensure sufficient granularity, e.g., ns for time, and ppb for frequency. Note that even though these messages ensure the correct operation of the RU (time and frequency), their arrival times at RU are not critical, as packet delay variation in hundreds of microseconds will have only a small, if any, impact on the RU's performance.

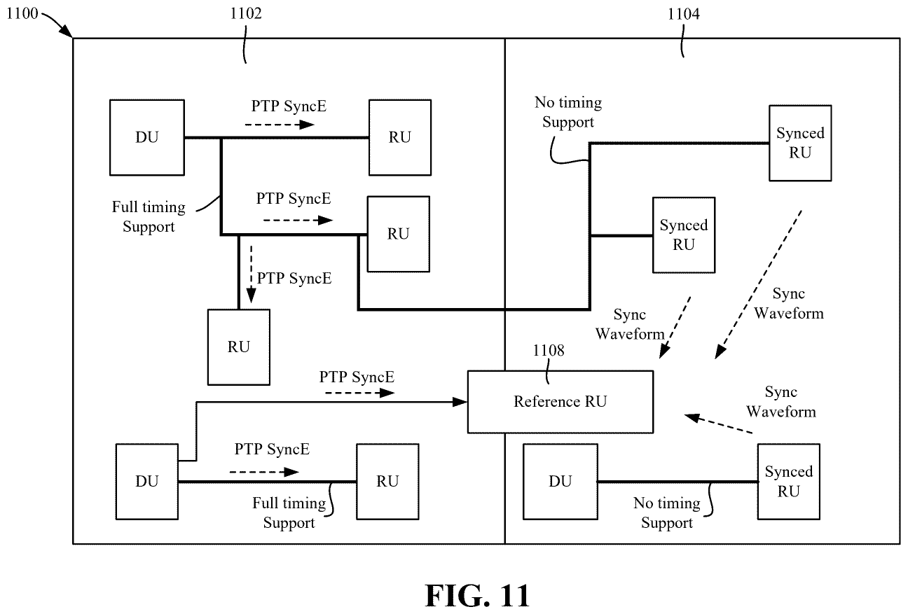

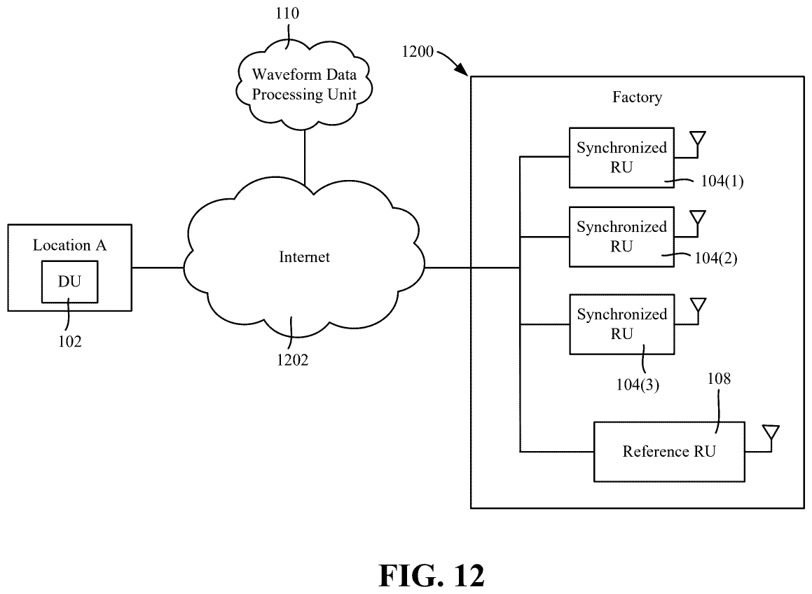

The examples of FIGS. 11 and 12 leverage the technology described herein to extend 4G or 5G coverage to locations where existing Ethernet (layer-2) or Internet (UDP/IP) networks provide only partial or no timing support. In the example of FIG. 11, consider that an operator A wants to provide network coverage in a factory 1100. One part 1102 of the facility uses a new network with full timing support and high throughput, allowing the radio units' time and frequency synchronization via a fronthaul interface. However, a part 1104 of the facility uses an old network which does not provide timing support. Deployment using this network would degrade the time and frequency synchronization of those RUs.

Instead of upgrading the existing network to support full timing, the operator leverages one or more radio units to extend the synchronization onto units connecting to the old network. To this end, one or more of these RUs can act as reference RUs (e.g., block 1108), which ensures synchronization for the remaining radio units.

In the example of FIG. 12, consider that an Operator X wants to provide 5G network coverage in a factory building 1200 in which the existing network does not provide timing support. The operator decides to deploy RUs (e.g., 104(1)-104(3)) supporting UDP/IP encapsulation that will communicate with a remote DU 102 via the internet 1202, e.g., using existing fibre/copper connections and leveraging a local reference RU 108 (or reference RUs) to ensure correct timing and frequency. As described herein because of the availability of synchronization using the reference RU 108, a jitter introduced by the internet and the factory's network has a negligible impact. The technology described herein thus allows relatively fast and inexpensive deployment of the service without needing to upgrade the factory's existing network.

As another example, (not explicitly shown) consider RUs from four operators, A. B, C, and D, that use different frequency bands, all located on the same tower, covering the same sector. A company, e.g., “Company X” (for example, a start-up) offers a service based on reference RUs using the technology described. The Company X has its reference RUs close to the tower. As a result, it can allocate time and frequency resources to synchronize all RUs, providing a scalable solution that reduces network complexity for fronthaul connections. Operators A, B, C, and D can use the service to avoid modifying the existing network, which does not provide full-timing support.

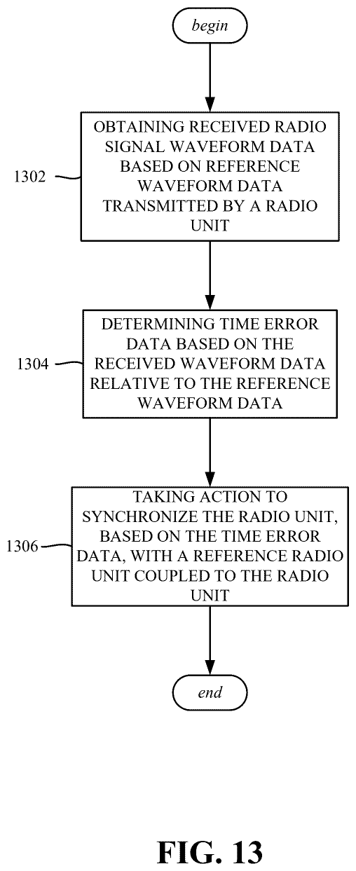

One or more aspects can be embodied in a system, such as represented in the example operations of FIG. 13, and for example can include a memory that stores computer executable components and/or operations, and a processor that executes computer executable components and/or operations stored in the memory. Example operations can include operation 1302, which represents obtaining received radio signal waveform data based on reference waveform data transmitted by a radio unit. Example operation 1304 represents determining time error data based on the received waveform data relative to the reference waveform data. Example operation 1306 represents taking action to synchronize the radio unit, based on the time error data, with a reference radio unit coupled to the radio unit.

Taking the action to synchronize the radio unit can include communicating the time error data to a distributed unit to be forwarded to the radio unit.

The action can include a first action, and further operations can include determining frequency error data based on the received radio signal waveform data relative to the reference waveform data, and taking second action to correct the (e.g., transmission) frequency of the radio unit based on the frequency error data. Determining the frequency error data can include obtaining first frequency domain sample data corresponding to the received radio signal waveform data transformed into the frequency domain, obtaining second frequency domain sample data corresponding to the reference waveform data transformed into the frequency domain, and correlating the first frequency domain sample data with the second frequency domain sample data in the frequency domain.

Taking the second action to correct the frequency of the radio unit oscillator based on the frequency error data can include communicating the frequency error data to a distributed unit for forwarding to the radio unit. This can include, but is not limited to, correcting the RU's oscillator frequency, for example the VCO's frequency, as the result of computed frequency error; correcting the transmission frequency, e.g., synthesized from the VCO's frequency using a phase-locked loop; correcting the clock frequency of the RU's timer module based on the VCO. further reducing the time drift, i.e. the time error increment between subsequent resynchronizations, correcting the clock frequency for digital and analog RU subsystems based on the VCO frequency (these may include but are not limited to, Ethernet PHY, Low-PHY, digital front end including ADC and DAC, and the like), and/or correcting the clock frequency for any other subsystems not explicitly set forth herein that can benefit from a high-accuracy clock based on RU's VCO.

The action can include a first action, and further operations can include obtaining quality information associated with the received radio signal waveform data, and taking second action to return quality indication data, corresponding to the quality information, to a distributed unit.

The system can include a reference receiver component, and further operations can include obtaining the received radio signal waveform data via the reference receiver component. The reference receiver component can include the reference radio unit to which the radio unit is synchronized.

Determining of the time error data can include compensating for radio unit propagation time data based on predefined distance data representative of a distance between the radio unit and the reference receiver component.

The system further can include a waveform data processing component coupled to the reference receiver component; the processing component can coordinate the reference waveform data with the distributed unit, and determining the time error data can include outputting sample data representative of the received radio signal waveform data from the reference receiver component to the processing component.

The sample data representative of the radio signal waveform data can include real data and imaginary data.

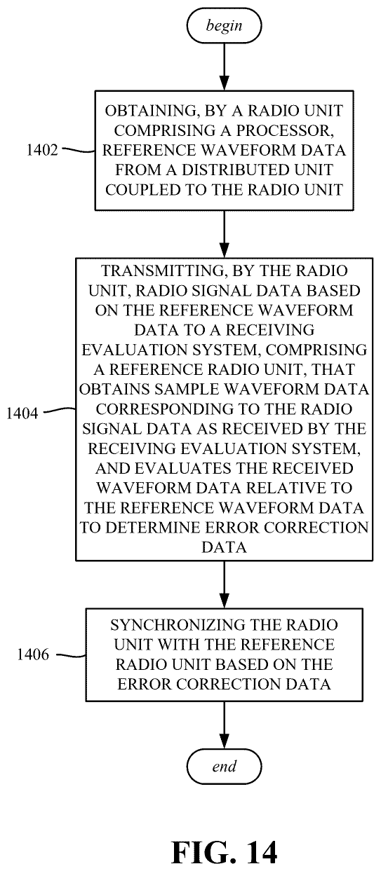

One or more example aspects, such as corresponding to example operations of a method, are represented in FIG. 14. Example operation 1402 represents obtaining, by a radio unit comprising a processor, reference waveform data from a distributed unit coupled to the radio unit. Example operation 1402 represents transmitting, by the radio unit, radio signal data based on the reference waveform data to a receiving evaluation system, comprising a reference radio unit, that obtains sample waveform data corresponding to the radio signal data as received by the receiving evaluation system, and evaluates the received waveform data relative to the reference waveform data to determine error correction data. Example operation 1406 represents synchronizing the radio unit with the reference radio unit based on the error correction data.

Synchronizing the radio unit with the reference radio unit can include obtaining the error correction data by the radio unit from the distributed unit. Obtaining the error correction data can include receiving a message from the distributed unit.

The reference waveform data can include reference frequency data, the error correction data can include frequency error data, and synchronizing the radio unit with the reference radio unit can be based on the reference frequency data and the frequency error data.

The reference waveform data can include reference timing data, the error correction data can include timing error data, and synchronizing of radio unit with the reference radio unit can be based on the reference timing data and the timing error data.

Further operations can include obtaining, by the distributed unit, signal quality information based on the transmitting of the radio signal data, and adjusting, by the distributed unit, subsequent transmissions, subsequent to the transmitting of the radio signal data, based on the radio unit signal quality information.

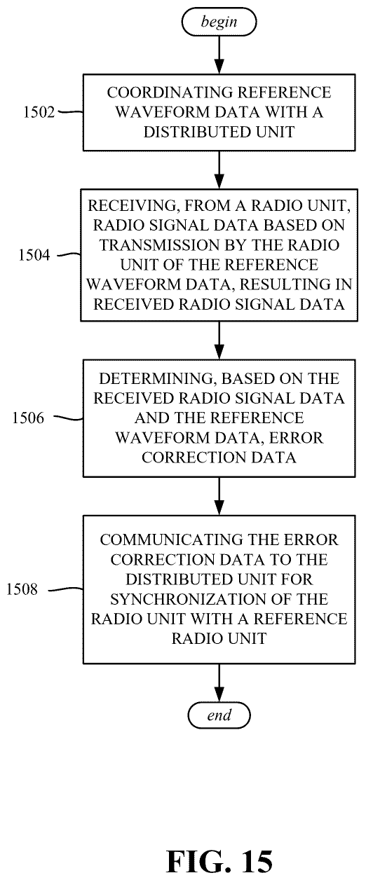

FIG. 15 summarizes various example operations, e.g., corresponding to a machine-readable medium, comprising executable instructions that, when executed by a processor of a system, facilitate performance of operations. Example operation 1502 represents coordinating reference waveform data with a distributed unit. Example operation 1504 represents receiving, from a radio unit, radio signal data based on transmission by the radio unit of the reference waveform data, resulting in received radio signal data. Example operation 1506 represents determining, based on the received radio signal data and the reference waveform data, error correction data. Example operation 1508 represents communicating the error correction data to the distributed unit for synchronization of the radio unit with a reference radio unit.

The system can include a reference receiver component coupled to a waveform data processing component, obtaining the received radio signal data can include receiving the received radio signal data at the reference receiver component, further operations can include providing sample data representative of the radio signal data from the reference receiver component to the waveform data processing component, and determining the error correction data can include evaluating, by the waveform data processing component, the sample data relative to the reference waveform data.

Determining the error correction data can include determining at least one of: time error data or frequency error data.

As can be seen, the technology described herein facilitates synchronization of radio units with a reference radio unit without the need for additional hardware and signaling such as currently used with boundary-clock-based synchronization. Instead, a radio unit to be synchronized transmits a signal that is used to evaluate its time and frequency. A reference radio unit receives waveforms from online synchronized RUs and outputs data sampled using reference time and frequency. A (e.g., scalable) processing unit that evaluates the received waveform sample data relative to reference waveform data and returns feedback, which can include frequency error data, time error data, and quality indication information. The frequency error data and time error data are used to synchronize a RU, while the quality indication informs the RAN of the health of the air interface and facilitates closed-loop adjustments.

In one implementation, the technology described herein provides for messages between the DU and RU (e.g., via a fronthaul interface). Messages from the DU to the radio unit and the processing unit indicate the reference waveform, including start time, stop time and frequency for transmitting (by the RU) and evaluating the received waveform (by the processing unit). Another message carries a request to the synchronized RU to correct its time and frequency based on the error data.

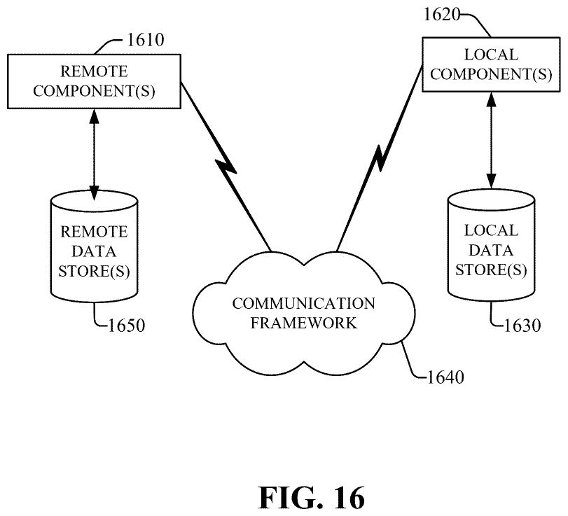

FIG. 16 is a schematic block diagram of a computing environment with which the disclosed subject matter can interact. The system of FIG. 16 comprises one or more remote component(s) 1610. The remote component(s) 1610 can be hardware and/or software (e.g., threads, processes, computing devices). In some embodiments, remote component(s) 1610 can be a distributed computer system, connected to a local automatic scaling component and/or programs that use the resources of a distributed computer system, via communication framework 1640. Communication framework 1640 can comprise wired network devices, wireless network devices, mobile devices, wearable devices, radio access network devices, gateway devices, femtocell devices, servers, etc.

The system of FIG. 16 also comprises one or more local component(s) 1620. The local component(s) 1620 can be hardware and/or software (e.g., threads, processes, computing devices). In some embodiments, local component(s) 1620 can comprise an automatic scaling component and/or programs that communicate/use the remote resources 1610, etc., connected to a remotely located distributed computing system via communication framework 1640.

One possible communication between a remote component(s) 1610 and a local component(s) 1620 can be in the form of a data packet adapted to be transmitted between two or more computer processes. Another possible communication between a remote component(s) 1610 and a local component(s) 1620 can be in the form of circuit-switched data adapted to be transmitted between two or more computer processes in radio time slots. The system of FIG. 16 comprises a communication framework 1640 that can be employed to facilitate communications between the remote component(s) 1610 and the local component(s) 1620, and can comprise an air interface, e.g., Uu interface of a UMTS network, via a long-term evolution (LTE) network, etc. Remote component(s) 1610 can be operably connected to one or more remote data store(s) 1650, such as a hard drive, solid state drive, SIM card, device memory, etc., that can be employed to store information on the remote component(s) 1610 side of communication framework 1640. Similarly, local component(s) 1620 can be operably connected to one or more local data store(s) 1630, that can be employed to store information on the local component(s) 1620 side of communication framework 1640.

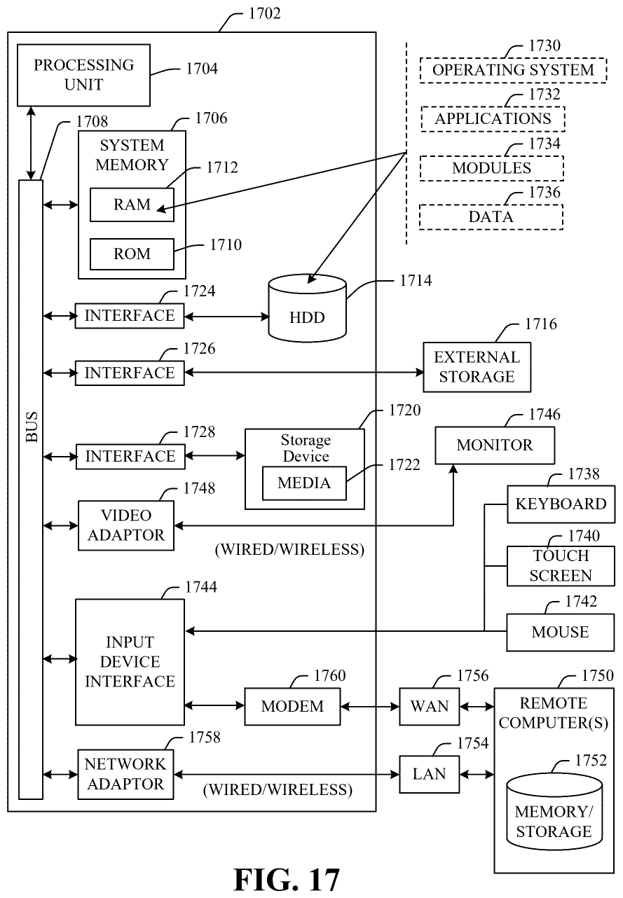

In order to provide additional context for various embodiments described herein, FIG. 17 and the following discussion are intended to provide a brief, general description of a suitable computing environment of FIG. 17 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein also can be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), persistent memory (PMEM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment of FIG. 17 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), and can include one or more external storage devices 1716 (e.g., a magnetic floppy disk drive (FDD) 1716, a memory stick or flash drive reader, a memory card reader, etc.). While the internal HDD 1714 is illustrated as located within the computer 1702, the internal HDD 1714 can also be configured for external use in a suitable chassis (not shown). Additionally, while not shown in the environment of FIG. 17, a solid state drive (SSD) could be used in addition to, or in place of, an HDD 1714.

Other internal or external storage can include at least one other storage device 1720 with storage media 1722 (e.g., a solid state storage device, a nonvolatile memory device, and/or an optical disk drive that can read or write from removable media such as a CD-ROM disc, a DVD, a BD, etc.). The external storage 1716 can be facilitated by a network virtual machine. The HDD 1714, external storage device(s) 1716 and storage device (e.g., drive) 1720 can be connected to the system bus 1708 by an HDD interface 1724, an external storage interface 1726 and a drive interface 1728, respectively.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1794 serial port, a game port, a USB port, an IR interface, a BLUETOOTH® interface, etc.

A monitor 1746 or other type of display device also can be connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the Internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are examples and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
obtaining received radio signal waveform data based on reference waveform data transmitted by a radio unit;
determining time error data based on the received waveform data relative to the reference waveform data; and
taking action to synchronize the radio unit, based on the time error data, with a reference radio unit coupled to the radio unit.

2. The system of claim 1, wherein the taking of the action to synchronize the radio unit comprises communicating the time error data to a distributed unit to be forwarded to the radio unit.

3. The system of claim 1, wherein the action is a first action, and wherein the operations further comprise determining frequency error data based on the received radio signal waveform data relative to the reference waveform data, and taking second action to correct a frequency of the radio unit based on the frequency error data.

4. The system of claim 3, wherein the determining of the frequency error data comprises obtaining first frequency domain sample data corresponding to the received radio signal waveform data transformed into the frequency domain, obtaining second frequency domain sample data corresponding to the reference waveform data transformed into the frequency domain, and correlating the first frequency domain sample data with the second frequency domain sample data in the frequency domain.

5. The system of claim 3, wherein the taking of the second action to correct the frequency of the radio unit oscillator based on the frequency error data comprises communicating the frequency error data to a distributed unit for forwarding to the radio unit.

6. The system of claim 1, wherein the action is a first action, and wherein the operations further comprise obtaining quality information associated with the received radio signal waveform data, and taking second action to return quality indication data, corresponding to the quality information, to a distributed unit.

7. The system of claim 1, wherein the system comprises a reference receiver component, and wherein the operations further comprise obtaining the received radio signal waveform data via the reference receiver component.

8. The system of claim 7, wherein the reference receiver component comprises the reference radio unit to which the radio unit is synchronized.

9. The system of claim 7, wherein the determining of the time error data comprises compensating for radio unit propagation time data based on predefined distance data representative of a distance between the radio unit and the reference receiver component.

10. The system of claim 7, wherein the system further comprises a waveform data processing component coupled to the reference receiver component, wherein the processing component coordinates the reference waveform data with the distributed unit, and wherein the determining of the time error data comprises outputting sample data representative of the received radio signal waveform data from the reference receiver component to the processing component.

11. The system of claim 10, wherein the sample data representative of the radio signal waveform data comprises real data and imaginary data.

12. A method, comprising:
obtaining, by a radio unit comprising a processor, reference waveform data from a distributed unit coupled to the radio unit;
transmitting, by the radio unit, radio signal data based on the reference waveform data to a receiving evaluation system, comprising a reference radio unit, that obtains sample waveform data corresponding to the radio signal data as received by the receiving evaluation system, and evaluates the received waveform data relative to the reference waveform data to determine error correction data; and
synchronizing the radio unit with the reference radio unit based on the error correction data.

13. The method of claim 12, wherein the synchronizing of the radio unit with the reference radio unit comprises obtaining the error correction data by the radio unit from the distributed unit.

14. The method of claim 13, wherein the obtaining of the error correction data comprises receiving a message from the distributed unit.

15. The method of claim 12, wherein the reference waveform data comprises reference frequency data, wherein the error correction data comprises frequency error data, and wherein the synchronizing of the radio unit with the reference radio unit is based on the reference frequency data and the frequency error data.

16. The method of claim 12, wherein the reference waveform data comprises reference timing data, wherein the error correction data comprises timing error data, and wherein the synchronizing of the radio unit with the reference radio unit is based on the reference timing data and the timing error data.

17. The method of claim 12, further comprising obtaining, by the distributed unit, signal quality information based on the transmitting of the radio signal data, and adjusting, by the distributed unit, subsequent transmissions, subsequent to the transmitting of the radio signal data, based on the radio unit signal quality information.

18. A non-transitory machine-readable medium, comprising executable instructions that, when executed by a processor of a system, facilitate performance of operations, the operations comprising:
coordinating reference waveform data with a distributed unit;
receiving, from a radio unit, radio signal data based on transmission by the radio unit of the reference waveform data, resulting in received radio signal data;
determining, based on the received radio signal data and the reference waveform data, error correction data; and
communicating the error correction data to the distributed unit for synchronization of the radio unit with a reference radio unit.

19. The non-transitory machine-readable medium of claim 18, wherein the system comprises a reference receiver component coupled to a waveform data processing component, wherein the obtaining of the received radio signal data comprises receiving the received radio signal data at the reference receiver component, wherein the operations further comprise providing sample data representative of the radio signal data from the reference receiver component to the waveform data processing component, and wherein the determining of the error correction data comprises evaluating, by the waveform data processing component, the sample data relative to the reference waveform data.

20. The non-transitory machine-readable medium of claim 18, wherein the determining of the error correction data comprises determining at least one of: time error data or frequency error data.
